(19) United States
(12) Patent Application Publication
(10) Pub. No.: US 2005/0140575 A1
(43) Pub. Date: Jun. 30, 2005

(54) Real-time image warping method for curved screen

(76) Inventor: Wei-Lun Huang, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/851,634

(22) Filed: May 21, 2004

(30) Foreign Application Priority Data
Dec. 26, 2003 (TW) 92137046

(51) Int. Cl. G09G 1/08; G06T 11/20

(52) U.S. Cl. 345/15; 345/441; 345/442

(57) ABSTRACT

A method of processing a rectangular image for display on a curved screen. The method warps a real-time image and projects the warped image onto a curved screen without distortion.

### BACKGROUND OF THE INVENTION

1. Field of the Invention

The present invention relates to an image warping method for a curved screen, and more particularly to a real-time image warping method.

2. Description of the Related Art

In a conventionally virtual reality system, a screen surrounds users to provide an immersion effect. Joint seams occur when a combined image is formed by many small images projected by different projectors. A curved screen de-emphasizes seams for better immersion effect. Conventional projectors, however, are designed to project images only on a planar screen. If a conventional projector projects images on a curved screen, distortion can negatively affect the virtual experience.

FIG. 1 shows an exemplary image projected by a projector. When the projector projects an image 20 on a curved screen, a distorted image 22 appears. Distances from the projector to the sides compared to the middle of the screen are different, such that the lower portion of image 22 is distorted.

Several convention solutions have been developed. In one an image is processed by a warping method and then projected onto a curved screen. Such warping methods require numerous CPU operations if implemented by software. This solution is inexpensive but processing speed is low. Thus, it is best suited to process predictable images, such as those previously recorded. Real-time image displays, however, responding to random movement of a subject, are beyond the capability of this solution.

Warping performed by hardware with accelerated process speed while addressing those shortcomings is costly and increases maintenance requirements.

### SUMMARY OF THE INVENTION

Accordingly, an object of the present invention is to provide a simplified method of image warping, thereby increased processing speed, and decreasing cost and inconvenience.

The invention provides a method of processing a rectangular image for display on a curved screen by the following steps. First, a first plane region is defined in an image frame of a projector to display the rectangular image. The first plane region comprises first and second rectilinear boundaries parallel to each other. The first rectilinear boundary has first and second ends. Next, a curve is generated according to user input and passes through the first and second ends. Thereafter, a second plane region is defined in the image frame with the curve and the second rectilinear boundary as two boundaries. The rectangular image is warped to fit substantially the second plane region for projection onto the curved screen. Finally, the warped image is projected.

The first rectilinear boundary has a length of W. The rectangular image has a bottom pixel displayed on the first rectilinear boundary a distance of x away from the center of the first rectilinear boundary. The radius of the curve is R. The bottom pixel is moved forward to the second rectilinear boundary by a distance of

$$\sqrt{{R}^{2} - {x}^{2}} - \sqrt{{R}^{2} - {( \frac{W}{2} )}^{2}} .$$

The invention also provides a method for displaying a large-angle image onto a curved screen. The large-angle image comprises rectangular images. First, a curved screen is split into a plurality of regions. Thereafter, each rectangular image is warped to substantially fit into a corresponding region. Finally, each warped image is projected onto its corresponding region. The resulting projected image has a portion overlapping with a neighboring projected image.

### BRIEF DESCRIPTION OF THE DRAWINGS

The present invention can be more fully understood by reading the subsequent detailed description and examples with reference made to the accompanying drawings, wherein:

FIG. 1 shows an exemplary image projected by a projector;

FIG. 2a shows the method of processing a rectangular image of the present invention;

FIG. 2b shows the principle of the warping method of the present invention;

FIGS. 3a to 3c show the warping method of the present invention;

FIG. 4 shows an exemplary compressed image in a newly created area;

FIG. 5 shows another exemplary compressed image in the newly created area;

FIGS. 6a to 6c show steps of generating the curve defining the newly created area;

FIG. 7 shows another embodiment of the present invention;

FIG. 8 shows a warped image according to the present invention;

FIGS. 9a to 9b show the display method according to the present invention.

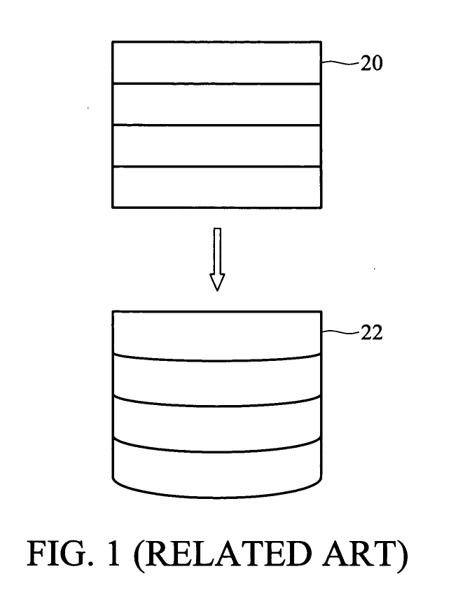

### DETAILED DESCRIPTION OF THE INVENTION

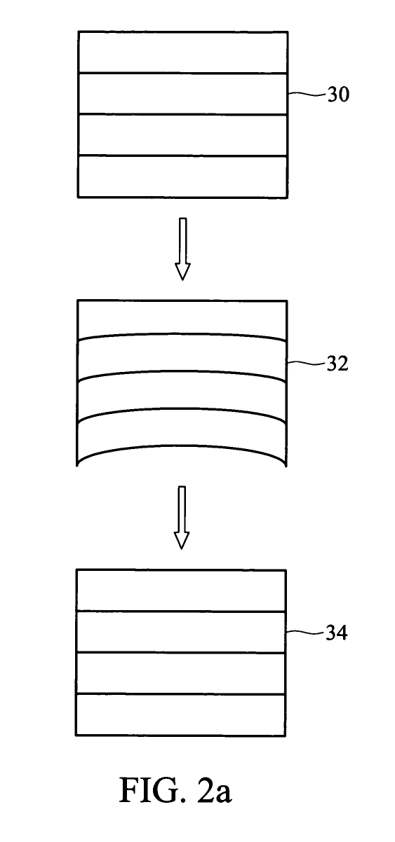

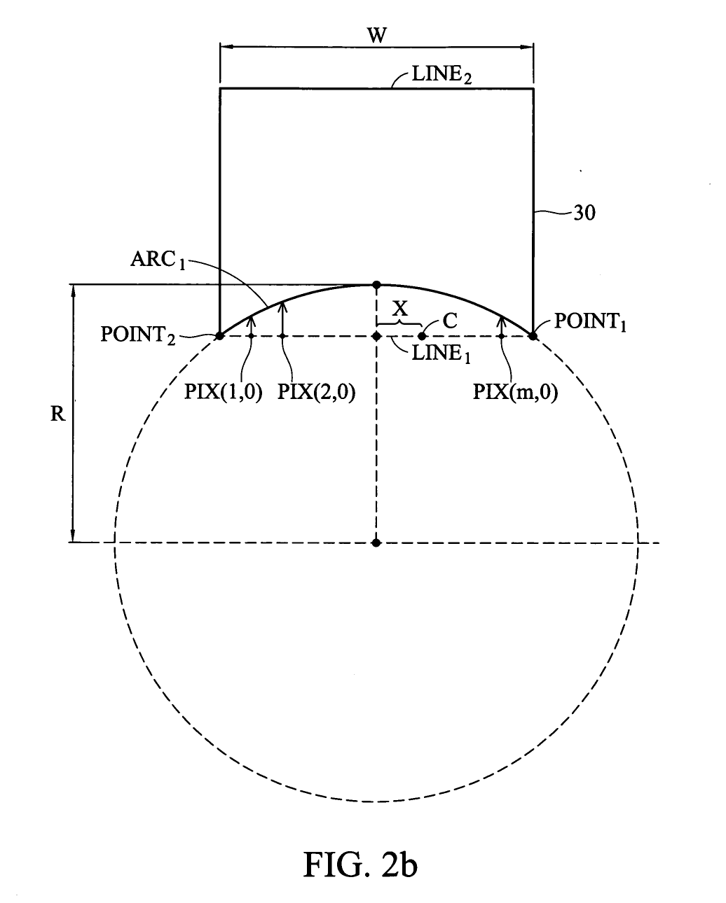

FIG. 2a shows the method of processing a rectangular image of the present invention. Original image 30 is normally rectangular is disposed in an image frame in a projector. Currently projects normally use LCDs for receiving image frames thereon for projection. Before projection, the image 30 is warped, resulting in warped image 32, which is the projected onto a curved screen generating undistorted projection image 34.

FIG. 2b shows the principle for image warping of the present invention. The area in the image frame is occupied by the image 30, defined as a rectangular zone with a top rectilinear boundary and a bottom rectilinear boundary. The bottom rectilinear boundary has two ends, POINT₁ and POINT₂. Curve ARC₁, passing POINT₁ and POINT₂, is thus defined. The center of Curve ARC₁ is located on a perpendicular bisector of the bottom rectilinear boundary. Another area is defined by the ARC₁, two vertical side walls and the top rectilinear boundary, into which a warped image 32 substantially fits. The definition method for ARC₁, is described here after. The image 30 is segmented into vertical sections, each compressed according to a shortened length defined by ARC₁. By combining sections, the compressed the warped image 32 is created and projected to corresponding to the rectangularity of the original image.

In FIG. 2b, a circle has a radius of R and a circumference passing through POINT₁ and POINT₂ with a distance between point C and the center of the bottom rectilinear boundary of x. The vertical distance between ARC₁, a segment of the circle, and point C can be derived by Equation 1:

$$\sqrt{{R}^{2} - {x}^{2}} - \sqrt{{R}^{2} - {( \frac{W}{2} )}^{2}}$$

A digital content creator (DCC) processing the warping method of the present invention in a projector or computer generates image 30, a rectangular image, fitting the newly created area in the image frame enclosed by ARC₁, two vertical side walls and the top rectilinear boundary. The bottom pixels of image 30 displayed at the bottom rectilinear boundary are moved by the DCC forward to the top rectilinear boundary according to the distance obtained from Equation 1. Since the DCC executes the warping method of the present invention in a processing device of the projector or a display card of the computer, the executing time of the DCC is short. All pixels in image 30 are also moved into the newly created area to generate warped image 32.

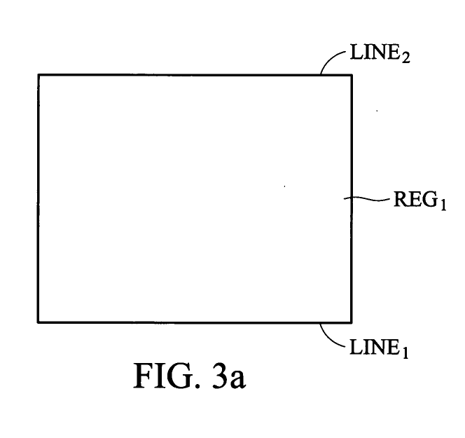

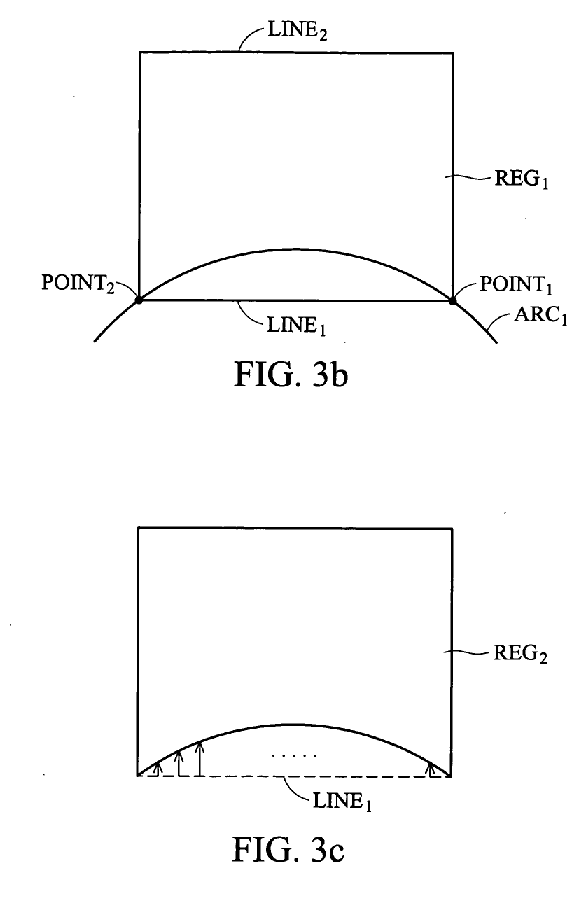

FIGS. 3a to 3c show the warping method of the present invention. First, in FIG. 3a, a plane region REG₁ in an image frame of a projector is defined to display an image 30. The plane region REG₁ has a top rectilinear boundary and a bottom rectilinear boundary, parallel to each other.

Next, as shown in FIG. 3b, a control panel of a projector or a connected computer allows a point on the bottom rectilinear boundary to be dragged define ARC₁ passing through POINT₁ and POINT₂.

As shown in FIG. 3c, a newly created area REG₂ in the image frame is defined by ARC₁, two vertical side walls and the top rectilinear boundary LINE₁. In FIG. 3c, the pixels on the bottom rectilinear boundary are moved forward by the DCC to ARC₁. Furthermore, the pixels in image 30 are also moved by the DCC into the newly created area to generate warped image 32.

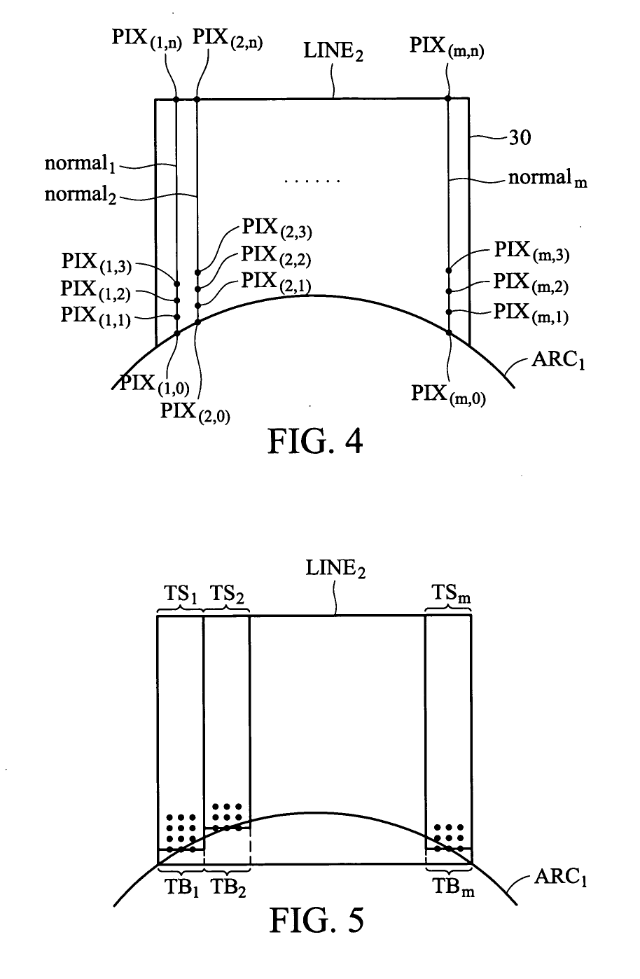

FIG. 4 shows an exemplary compressed image fitting the new created area. In FIG. 4, normal₁ to normalₘ are perpendicular to the bottom rectilinear boundary LINE₁. An original image is vertically split into columns sections, each only on a corresponding normal, consisting of pixels on the corresponding normal, thus defined as column pixels. Compression of a column section moves column pixels by the DCC along the corresponding normal and forward to the bottom rectilinear boundary LINE₁. The distance moved of a column pixel depends on the location of the corresponding normal and the gap on the normal between the curve ARC₁ and the bottom rectilinear boundary LINE₁. In this way, column pixels in a column section are separated by the same distance, near each other, stay on the same normal and relocate into the newly created area. FIG. 4 shows a result. PIX_{(1,0)}˜PIX_{(1,n)} is on normal₁ and PIX_{(2,0)}˜PIX_{(2,n)} is on normal₂. Furthermore, bottom pixels PIX_{(1,0)} and PIX_{(2,0)} are relocated to ARC₁. In FIG. 4, each bottom pixel is moved a distance according to Equation 1, resulting in precise positioning. Perfect fitting is the benefit of this embodiment.

FIG. 5 shows another exemplary compressed image substantially fitting into the new created area. Rather than covering only one normal in FIG. 4, in FIG. 5, each column section covers 3 corresponding normals, comprising corresponding column pixels thereon. Thus, an original image is vertically split into column sections, each rectangular with a top line TSₘ and a bottom line TBₘ and having lines of column pixels. The pixels with the same vertical height in the same column strip are moved by the DCC by the same distance to maintain a horizontal line. It is shown in FIG. 5 that a bottom line TBₘ of a compressed column section is substantially located on or across curve ARC₁, in order to fit the compressed image into the newly created area enclosed by curve ARC₁, the top rectilinear boundary LINE₂ and two vertical side walls.

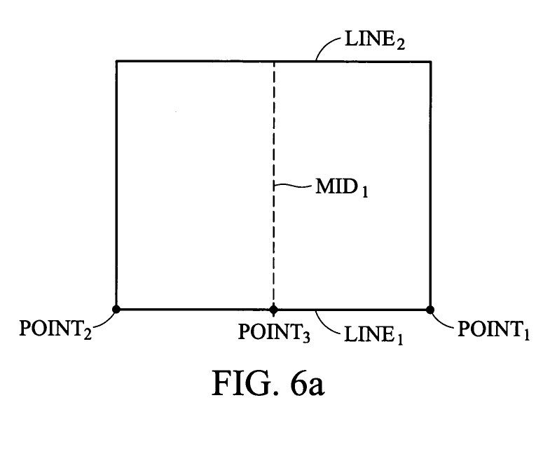

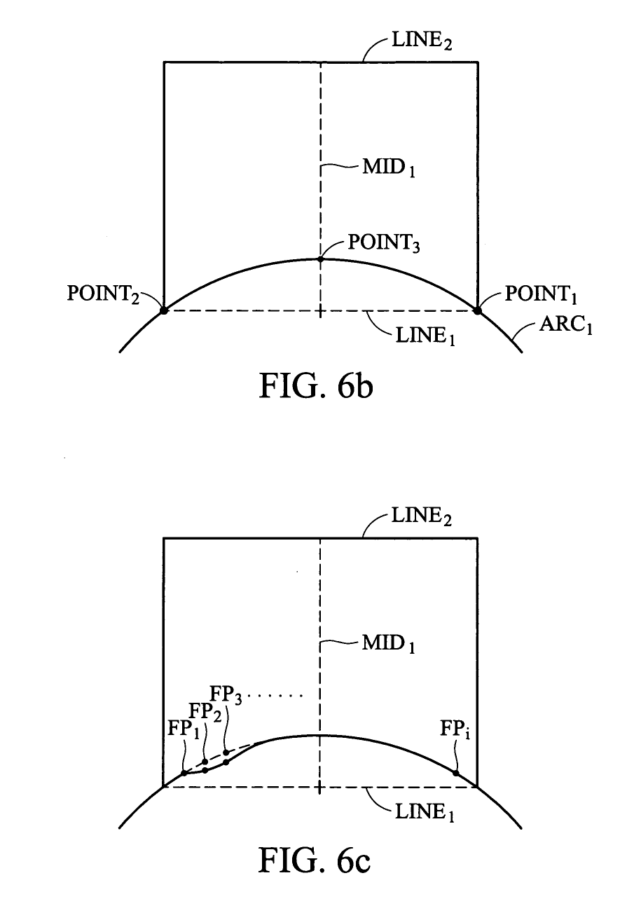

FIGS. 6a to 6c show steps of creating the curve to define the new created area. First, in FIG. 6a, a point POINT₃ at the center of the bottom rectilinear boundary LINE₁ is defined by the DCC as adjustable or moveable along a perpendicular bisector MID₁ of LINE₁. By moving POINT₃ along MID₁, ARC₁, which passes through POINT₁, POINT₂, and the moved POINT₃, can be defined and generated, with a primary newly created area accordingly defined, as shown in FIG. 6b. The distance between the adjustment point POINT₃ and the bottom rectilinear boundary LINE₁ thus becomes an adjustment parameter for the radian of the curve ARC₁. If the curvature of the primary new created area is insufficient for a warped image to appear undistorted, another fine-tuning step is introduced. In FIG. 6c, on ARC₁, points FP₁, FP₂, . . . , FP₁ are selected as fine-tunable points, while the location of POINT₃ is fixed. Moving any of the fine-tunable points generates movement of adjacent points to alter the curvature of ARC₁ by the DCC, thereby passing through all the fine tunable points. As shown in FIG. 6c, when FP₁ remains in the same place, FP₂ and FP₃ move slightly, ARC₁ is fine-tuned and is no longer a portion of a circle. By way of the fined-tuned ARC₁, another created area is defined and an image can be warped accordingly to be shown on a curved screen undistorted.

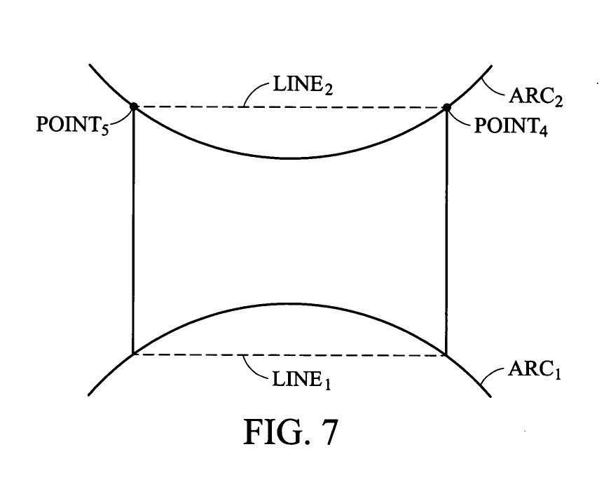

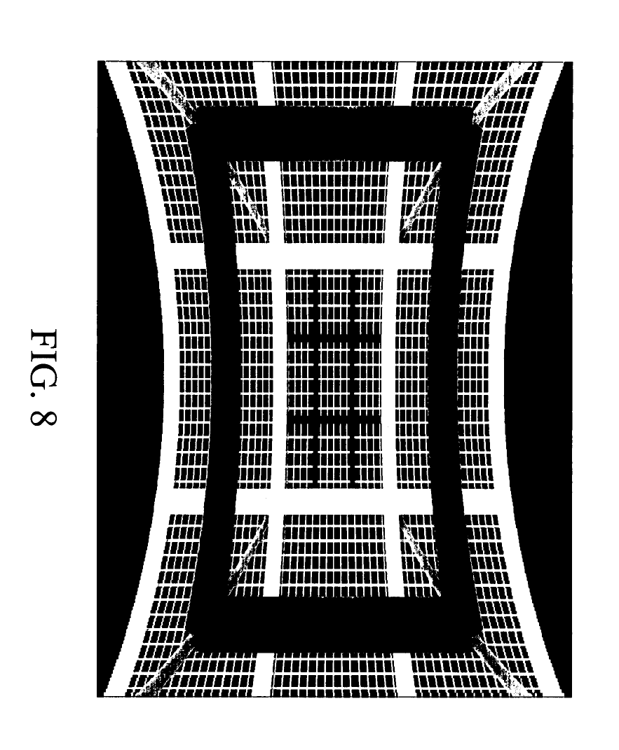

In addition to application to the bottom rectilinear boundary, the method of defining a curve can also be applied to the top rectilinear boundary. A curve ARC₂ is defined as shown in FIG. 7. The curve ARC₂ is defined by a control panel of the projector or the connected computer and passing two ends POINT₄ and POINT₅. Another area is defined in the image frame by the curves ARC₁ and curve ARC₂ and two vertical side walls. The image 30 is segmented into several vertical sections by the DCC and compressed according to a shortened length defined by curves ARC₁ and ARC₂. By combining the compressed sections, a warped image shown in FIG. 8 is created and projected onto a curved screen should be corresponding to the rectangularity of the original image.

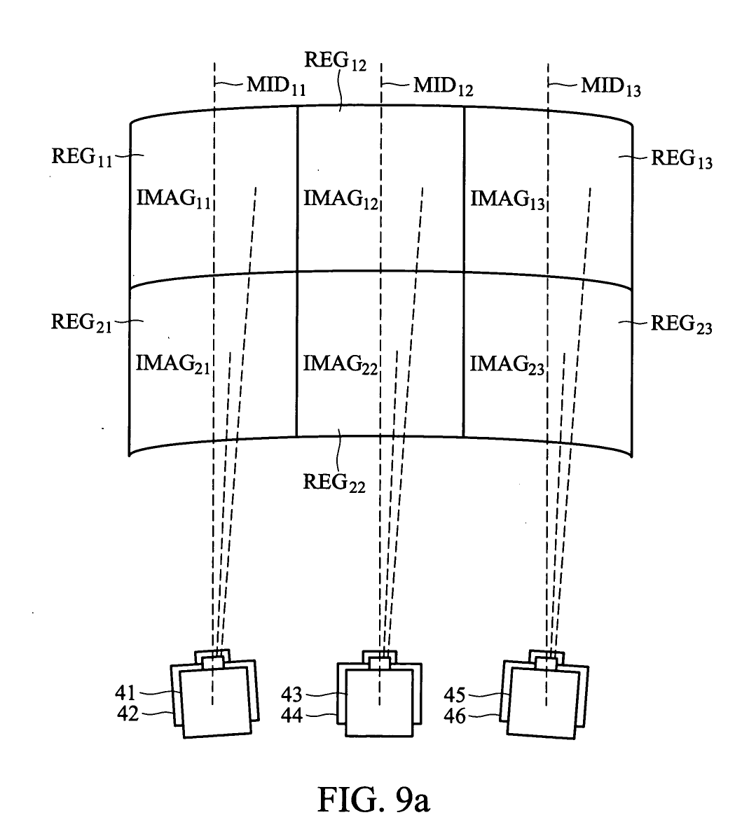

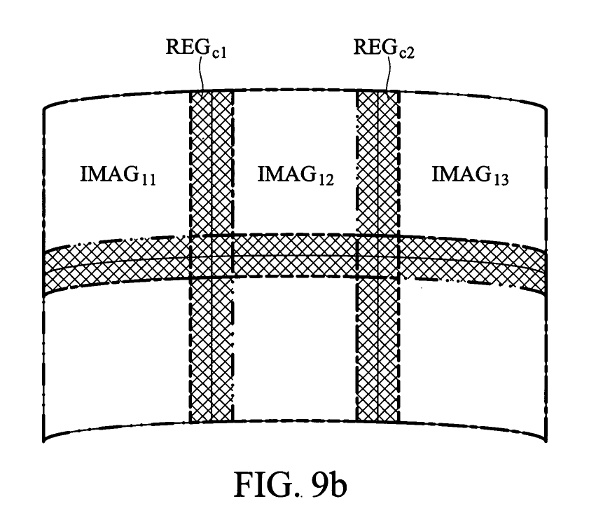

FIG. 9a shows images respectively projected from projectors on a single curved screen. For a panoramic or large-angle image, a single projector may not be enough. In FIG. 9a, projectors 41˜46 are provided, with projectors 41 and 42 stacked in a straight line MID₁₁, projectors 43 and 44 on MID₁₂, and projectors 45 and 46 on MID₁₃. The straight line MID₁₁, is a perpendicular bisector of REG₁₁ and REG₂₁. The straight line MID₁₂ is a perpendicular bisector of REG₁₂ and REG₂₂. The straight line MID₁₃ is a perpendicular bisector of REG₁₃ and REG₂₃.

The curved screen is split into regions REG₁₁˜REG₂₃. Each projector projects a warped image onto the corresponding region of the curved screen. Each warped image can be generated by the method of processing a rectangular image disclosed.

To avoid image discontinuity or gap between projected images, each the warped image IMAG₁₁˜IMAG₂₃ is preferably larger than its corresponding region on the curved screen. As shown in FIG. 9b, image IMAGL₁ overlaps image IMAG₁₂ in portion REG_{c1} and image IMAG₁₂ with image IMAG₁₃ in portion REG_{c2}.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of processing a rectangular image for display on a curved screen, comprising:
defining a first plane region with dimensions corresponding to those of rectangular image on an image frame, the first plane region comprising first and second rectilinear boundaries parallel to each other, the first rectilinear boundary having first and second ends;
generating a curve passing through the first and second ends according to user input;
defining a second plane region with the curve and the second rectilinear boundary as two boundaries on the image frame;
warping the rectangular image to substantially fit into the second plane region; and
projecting the warped image onto the curved screen.

2. The method as claimed in claim 1, wherein the first rectilinear boundary has a length of W, the rectangular image has a bottom pixel displayed on the first rectilinear boundary a distance of x away from the center of the first rectilinear boundary, and warping comprises moving the bottom pixel forward to the second rectilinear boundary by a distance of
$$\sqrt{{R}^{2} - {x}^{2}} - \sqrt{{R}^{2} - {( \frac{W}{2} )}^{2}} ,$$
wherein R is the radius of the curve.

3. The method as claimed in claim 2, wherein a normal perpendicular to the first rectilinear boundary passes the bottom pixel, the rectangular image has a plurality of column pixels on the normal, and warping further comprises moving the column pixels along the normal and forward to the second rectilinear boundary, to relocate the moved column pixels within the second plane region.

4. The method as claimed in claim 2, wherein warping comprises:
dividing the rectangular image with pixels into column sections perpendicular to the first rectilinear boundary, each column section comprising a top line and a bottom line; and
compressing the column sections to relocate the top lines on the second rectilinear boundary and the bottom line substantially on the curve.

5. The method as claimed in claim 1, wherein generating the curve comprises:
defining an adjustment point on the first rectilinear boundary; and
moving the adjustment point to define the curve passing through the adjustment point, the first end and the second end.

6. The method as claimed in claim 5, wherein the distance from the adjustment point to the first rectilinear boundary is an adjustment parameter for the radian of the curve.

7. The method as claimed in claim 6, wherein generating the curve comprises, after moving the adjustable point, defining fine-tunable points on the curve and moving the fine-tunable points to alter the curvature of the curve so as that the curve passes through the moved fine-tunable points, the adjustment point, the first end and the second end.

8. The method as claimed in claim 7, wherein one point on the curve is adjusted such that the others near the adjusted point are also adjusted according to a specific relation.

9. A method for projecting a plurality of rectangular images onto a curved screen, comprising:
separating the curved screen into a plurality of regions;
providing the rectangular images;
warping each rectangular image to substantially fit into a corresponding region; and
projecting each warped image onto the corresponding region, with portions overlapping neighboring projected images.

10. The method as claimed in claim 9, wherein projecting comprises:
providing a plurality of projectors stacked in a straight line; and
using the projectors to project warped images onto corresponding regions.

11. The method as claimed in claim 9, wherein warping comprises defining a plurality of first plane regions with dimensions corresponding to those of rectangular images on an image frame, wherein each first plane region comprises first and second rectilinear boundaries parallel to each other, the first rectilinear boundary having first and second ends;
generating a curve according to user input, the curve passing through the first and the second ends;
defining a second plane region with the curve and the second rectilinear boundary as two boundaries on the image frame; and
warping the corresponding rectangular image to substantially fit into the second plane region for projection onto the curved screen.

12. The method as claimed in claim 11, wherein the first rectilinear boundary has a length of W, the rectangular image has a bottom pixel displayed on the first rectilinear boundary a distance of x away from the center of the first rectilinear boundary, and warping comprises moving the bottom pixel forward to the second rectilinear boundary by a distance of
$$\sqrt{{R}^{2} - {x}^{2}} - \sqrt{{R}^{2} - {( \frac{W}{2} )}^{2}} ,$$
wherein R is the radius of the curve.

13. The method as claimed in claim 12, wherein a normal perpendicular to the first rectilinear boundary passes the bottom pixel, the rectangular image has a plurality of column pixels on the normal, and warping further comprises moving the column pixels along the normal and forward to the second rectilinear boundary, so as to relocate the moved column pixels within the second plane region.

14. The method as claimed in claim 12, wherein warping step comprises:
dividing the rectangular image with pixels into column sections perpendicular to the first rectilinear boundary, each column section comprising a top line and a bottom line; and
compressing the column sections to relocate the top lines on the second rectilinear boundary and the bottom line substantially on the curve.

15. The method as claimed in claim 11, wherein generating the curve comprises:
defining an adjustment point on the center of the first rectilinear boundary; and
moving the adjustment point to generate the curve passing through the adjustment point, the first end and the second end.

16. The method as claimed in claim 15, wherein the distance from the adjustment point to the first rectilinear boundary is an adjustment parameter for the radian of the curve.

17. The method as claimed in claim 16, wherein generating the curve comprises, after moving the adjustable point, defining fine-tunable points on the curve, moving the fine-tunable points to alter the curvature of the curve so as that the curve passes through the moved fine-tunable points, the adjustment point, the first end and the second end.

18. The method as claimed in claim 17, wherein one point on the curve is adjusted such that the other near the adjusted points are also adjusted according to a specific relation.
